(19) United States
(12) Patent Application Publication
(10) Pub. No.: US 2008/0273049 A1
(43) Pub. Date: Nov. 6, 2008

(54) Ascent and Descent Apparatus for Liquid Material Spray Printer

(75) Inventor: Hyung-Dae Moon, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: BRAIN UNION SYSTEM CO., LTD., Seoul (KR)

(21) Appl. No.: 11/597,237

(22) PCT Filed: May 17, 2005
(86) PCT No.: PCT/KR05/01450

§ 371 Date: Nov. 20, 2006

(30) Foreign Application Priority Data
May 20, 2004 (KR) 10-2004-0036045

(51) Int. Cl. B41J 25/308

(52) U.S. Cl. 347/8

(57) ABSTRACT

Disclosed is an ascent and descent apparatus for a liquid material spray printer, which may control a distance between a subject to be coated and a spray assembly optimally. The apparatus includes a predetermined number of rotary shafts installed in a vertical direction and having spiral ridges on outer circumferences thereof, the rotary shafts being selectively rotated by a driving motor; and a lifting member installed to the rotary shafts to support a transferring table to which a subject to be coated is mounted, the lifting member having a spiral ridge with a shape conforming to the spiral ridges of the rotary shafts so that the transferring table is lifted when the rotary shafts are rotated.

### TECHNICAL FIELD

The present invention relates to an ascent and descent apparatus for a liquid material spray printer, and more particularly to an ascent and descent apparatus for a liquid material spray printer, which may control a distance between a subject to be coated and a spray assembly optimally.

### BACKGROUND ART

Generally, a liquid material spray printer is a device for coating liquid material on a surface of a subject to print a predetermined image. As an example of such a liquid material spray printer, there is an ink-jet printer that may coats an ink material for printing.

The liquid material spray printer includes a transferring table on which a subject to be coated is mounted, a transferring device for reciprocating the transferring table so that liquid material may be coated on the subject, an ascent and descent device for ascending/descending the transferring device to a height suitable for liquid material coating, and a spray assembly installed at a substantial center of the transferring device to be capable of reciprocating in a direction perpendicular to a moving direction of the transferring table. The spray assembly contains liquid material and is provided with a nozzle capable of spraying the liquid material to the subject to be coated. Such a liquid material spray printer is disclosed in Korean Utility Model Registration Nos. 20-0300099 and 20-0290304.

However, the liquid material spray printer may print an image only on a subject with a regulated size since a distance between the spray assembly and the transferring table is previously set. That is to say, it is impossible to print images on subjects with various sizes and shapes by using only one liquid material spray printer.

In particular, as interests for product advertisement are recently increased and designs become diversified, there is a need for a liquid material spray printer that is capable of printing various images with various colors on surfaces of subjects with various sizes and shapes.

### DISCLOSURE OF INVENTION

### Technical Problem

The present invention is designed to solve the problems of the prior art, and therefore an object of the invention is to provide an ascent and descent apparatus for a liquid material spray printer, which may control a distance between a subject to be coated and a spray assembly to an optimal coating distance required for printing so that it may be used for subjects with various sizes and shapes.

### Technical Solution

In order to accomplish the above object, the present invention provides an ascent and descent apparatus for a liquid material spray printer, which includes a pre-determined number of rotary shafts installed in a vertical direction and having spiral ridges on outer circumferences thereof, the rotary shafts being selectively rotated by a driving motor; and a lifting member installed to the rotary shafts to support a transferring table to which a subject to be coated is mounted, the lifting member having a spiral ridge with a shape conforming to the spiral ridges of the rotary shafts so that the transferring table is lifted when the rotary shafts are rotated.

Preferably, the rotary shafts include a shaft gear installed to each of the rotary shafts; and a driving force transferring member installed for connecting the shaft gears with each other so as to transfer a driving force, whereby at least two driving rotary shaft are selectively rotated using one driving motor at the same time.

More preferably, the ascent and descent apparatus for a liquid material spray printer further includes a tension pulley installed between the rotary shafts to make the driving force transferring member be curved so that a predetermined tension is provided to the driving force transferring member.

In addition, the ascent and descent apparatus for a liquid material spray printer may further include a sensor for sensing a distance between the subject installed to the transferring table and a spray assembly for spraying liquid material; and a controller for comparing the distance with an optimal coating distance required for printing and then selectively operating the driving motor.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a perspective view showing a liquid material spray printer to which an ascent and descent apparatus for a liquid material spray printer according to a preferred embodiment of the present invention is installed;

FIG. 2 is a plane view showing the liquid material spray printer of FIG. 1;

FIG. 3 is a sectional view taken along II-III′ line of FIG. 2;

FIG. 4 is a sectional view taken along IV-IV′ line of FIG. 1;

FIG. 5 is a perspective view showing a gearbox fixing device of the liquid material spray printer of FIG. 1; and

FIG. 6 is an exploded perspective view showing a slider member of FIG. 5.

### BEST MODE FOR CARRYING OUT THE INVENTION

The present invention will be described in detail referring to the drawings. the terms used should not be construed as limited to general and dictionary meanings but based on the meanings and concepts of the invention on the basis of the principle that the inventor is allowed to define terms appropriate for the best explanation. Therefore, the description herein the scope of the inventiont be understood that other and modifications could be made thereto without departing from the spirit and scope of the invention.

In addition, in this specification, in order to describe an ascent and descent apparatus for a liquid material spray printer according to a preferred embodiment of the present invention, a liquid material spray printer to which the ascent and descent apparatus is installed is also described together.

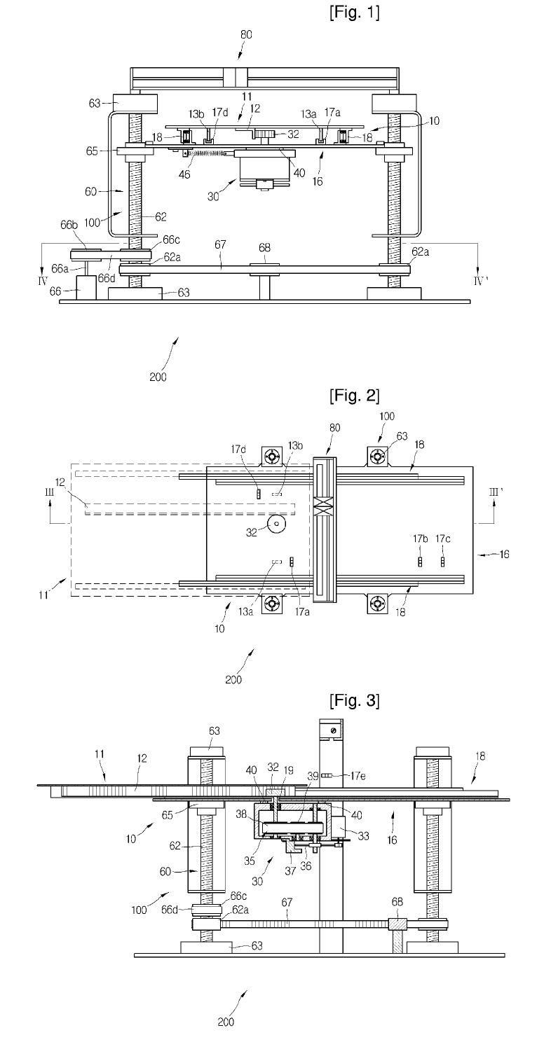

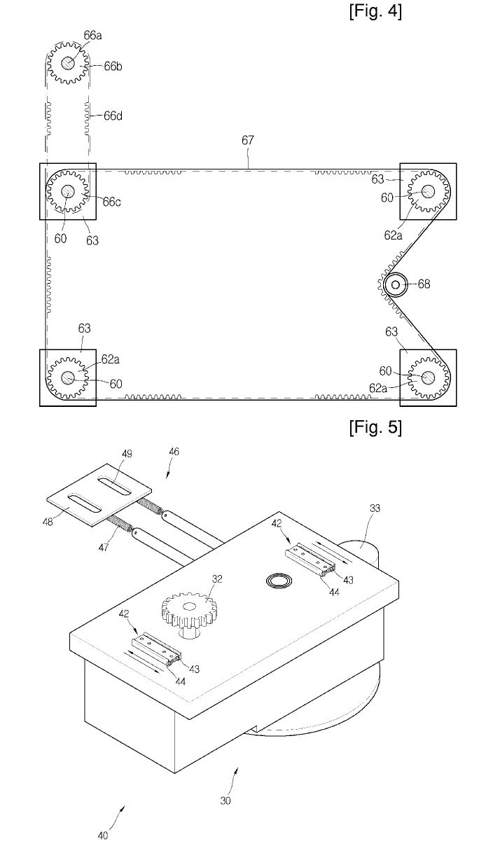

FIG. 1 is a front view showing a liquid material spray printer to which an apparatus for fixing a gearbox of the liquid material spray printer according to a preferred embodiment of the present invention is installed, FIG. 2 is a plane view showing the liquid material spray printer of FIG. 1, FIG. 3 is a sectional view taken along III-III′ line of FIG. 2, and FIG. 4 is a sectional view taken along IV-IV′ line of FIG. 1.

Referring to FIGS. 1 to 4, the liquid material spray printer 200 includes a transferring table 10 to which a subject to be coated is mounted, an ascent and descent apparatus 100 for lifting the transferring table 10, a gearbox 30 for reciprocating the transferring table 10, and a spray assembly 80 for coating liquid material.

The transferring table 10 includes a sliding flat table 11 on which a subject to be coated is mounted, and a guide flat plate 16 for guiding sliding movement of the sliding flat plate 11.

The sliding flat plate 11 includes a rack gear 12 installed in a length direction thereof, and protrusions 13a, 13b that are detected by sensors 17a, 17b, 17c, 17d sensing a printing range and a reciprocating range respectively.

The rack gear 12 is installed in a length direction on the lower surface of the sliding flat table 11 to be engaged with a pinion gear 32, as shown in FIGS. 2 and 3. As described later, the rack gear 12 is closely contacted with the pinion gear 32 by means of an elastic member 46.

The protrusions 13a, 13a include a first protrusion 13a detected by the first and second sensors 17a, 17b sensing the printing range and the third sensor 17c sensing an end position of the reciprocating range, and a second protrusion 13b detected by the fourth sensor 17d sensing a start position of the reciprocating range.

That is to say, if the sliding flat table 11 advances so that the first protrusion 13a reaches the first sensor 17a, the spray assembly 80 starts printing, while, if the first protrusion 13a reaches the second sensor 17b, the printing work is stopped. In addition, if the first protrusion 13a reaches the third sensor 17c, the sliding flat plate 11 stops advancing. And, if the sliding flat plate 11 moves rearward so that the second protrusion 13b reaches the fourth sensor 17d, the rear movement of the sliding flat table 11 is stopped.

The guide flat plate 16 is a flat plate to which the gearbox 16 is installed, and which is lifted by means of rotation of a rotary shaft 60. The guide flat plate 16 has a through hole 19 through which the pinion gear 32 is installed, a guide member 18 for guiding reciprocation of the sliding flat table 11, and sensors 17a, 17b, 17c, 17d sensing movement of the sliding flat table 11.

The through hole 19 is formed at a position that ensures close contact between the pinion gear 32 and the rack gear 12. The guide member 18 is installed to both side ends of the lower surface of the sliding flat plate 11 along its length direction and guides reciprocation of the sliding flat table 11. Such a guide member 18 is widely used in printers, and not described in detail here. Meanwhile, the sensors 17a, 17b, 17c, 17d are already described above, and not described again here.

The ascent and descent apparatus 100 is a device for reciprocating the transferring table 10 in a vertical direction within a predetermined range as shown in FIGS. 3 and 4. The ascent and descent apparatus 100 includes a rotary shaft 60 vertically installed, and a lifting member 65 installed to the rotary shaft 60 to vertically reciprocate the transferring table 10.

There are installed a predetermined number of rotary shafts 60, which are rotated by a driving motor 66. The rotary shaft 60 includes a spiral ridge 62 formed on its outer circumference, shaft gears 62a for transferring a driving force, and a driving force transferring member 67 installed for connecting the shaft gears 62a with each other so as to transfer a driving force.

There are installed a predetermined number of rotary shafts 60 according to a size of the transferring table 10. That is to say, though FIG. 4 shows four rotary shafts 60 are installed, the number of rotary shafts 60 may be suitably increased or decreased according to the size of the transferring table 10.

The spiral ridge 62 has a shape conforming to a spiral ridge formed on the inner circumference of the lifting member 65, and it makes the lifting member 65 be lifted when the rotary shaft 60 rotates.

The shaft gear 62a is installed to each rotary shaft 60 and transfer a driving force of the driving motor 66 to the rotary shaft 60. The shaft gears 62a are connected with each other by means of the driving force transferring member 67. That is to say, the shaft gears 62a installed to every rotary shaft 60 are interconnected by the driving force transferring member 67 and lift the transferring table 10 with rotating with the same revolution number.

The driving force of the driving motor 66 is transferred using a first driving gear 66b installed to a driving motor shaft 66a, a second driving gear 66c installed to the rotary shaft 60, and a belt 66d connecting the first and second driving gears 66b, 66c. Preferably, a tooth row is formed on the belt 66d so that the first and second driving gears 66b, 66c are engaged thereto. In addition, RPM of the driving motor 66 may be suitably controlled using the first and second driving gears 66b, 66c.

The driving force transferring member 67 transfers a driving force between the shaft gears 62a. The shaft gears 62a interconnected by the driving force transferring member 67 are rotated with the same RPM. Preferably, a tooth row to be engaged with the tooth row of the shaft gear 62a is formed on one side of the driving force transferring member 67. That is to say, the tooth rows are engaged to ensure that a driving force is accurately transferred among the shaft gears 62a.

Preferably, the ascent and descent apparatus 100 is provided with a tension pulley 68 that gives a predetermined tension to the driving force transferring member 67. The tension pulley 68 is installed between the rotary shafts 60 to curve a path of the driving force transferring member 67. Thus, the driving force transferring member 67 is closely contacted with the shaft gears 62a to transfer a driving force exactly.

Meanwhile, though FIGS. 1, 3 and 4 show that a driving force is transferred using the driving force transferring member 67 and the shaft gears 62a on which tooth rows are formed, the driving force may be transferred in various ways, not limited to the above case. For example, a driving force may be transferred using sprockets and chain installed to the rotary shafts 60.

Bearing members 63 are installed to upper and lower ends of the rotary shaft 60 to support rotation of the rotary shaft 60. The bearing member 63 has a common configuration supporting shaft behavior, and not described in detail here.

The lifting member 65 is installed to the rotary shaft 60 to support the transferring plate 10, and has a spiral ridge on its inner circumference, which is engaged with the spiral ridge of the rotary shaft 60. That is to say, the lifting member 65 lifts the transferring plate 10 with vertically reciprocating as the rotary shaft 60 rotates.

Preferably, the ascent and descent apparatus 100 includes a height sensor 17e for sensing a distance between the subject to be coated and the spray assembly 80, and a controller (not shown) for comparing the distance with an optimal coating distance required for printing and then selectively controlling the driving motor 33.

The height sensor 17e measures the distance between the subject to be coated and the spray assembly 80 and then sends its signal to the controller. The controller compares the distance between the subject to be coated and the spray assembly 80 with an optimal coating distance required for printing, and then selectively operates the driving motor 33.

As mentioned above, the ascent and descent apparatus 100 for a liquid material spray printer according to a preferred embodiment of the present invention may obtain an optimal coating distance suitable for printing by lifting the transferring table 10 according to size or shape of the subject. Thus, the liquid material spray printer 200 may be applied to subjects with various sizes and shapes.

The gearbox 30 is a unit for transferring a driving force from the driving motor 33 to the rack gear 12, as shown in FIGS. 3 and 5. The gearbox 30 includes a gear assembly 35 for regulating RPM, and a pinion gear 32 for transferring the driving force from the gear assembly 35 to the rack gear 12.

Preferably, the gear assembly 35 includes an encoder 36 and an encoder sensor 37 so as to control movement of the transferring table 10. That is to say, the rotation of the encoder 36 may be controlled using the encoder sensor 37 and the controller (not shown) so as to control movement of the transferring table 10.

In addition, the gear assembly 35 may further include a tension gear 39 giving a predetermined tension to a belt 38. The tension gear 39 makes the belt 38 move in a curved path, thereby giving a tension to the belt 38. The position of the tension gear 39 is controlled using a positioning unit (not shown). That is to say, the positioning unit is used for controlling a magnitude of the tension.

The pinion gear 32 having a common configuration is installed through the through hole 19 and transfers a driving force from the gear assembly 35 to the rack gear 12.

The gearbox 30 is installed below the guide flat plate 16 by use of the gearbox fixing device 40 as shown in FIGS. 3, 5 and 6.

The gearbox fixing device 40 includes a sliding member 42 for slidably coupling the gearbox 30 to the guide flat plate 16, and an elastic member 46 for biasing the pinion gear 32 to be closely contacted with the rack gear 12.

The sliding member 42 includes an upper slider 43 and a lower slider 44 that are combined to be slidable with each other in a length direction. The sliding member 42 is installed between the upper surface of the gearbox 30 and the guide flat plate 16 so that the gearbox 30 may slide within a predetermined range in a direction perpendicular to the reciprocating direction of the transferring table 10. That is to say, one of the upper and lower sliders 43, 44 is coupled to the guide flat plate 16, and the other of the upper and lower sliders 43, 44 is coupled to the upper surface of the gearbox 30.

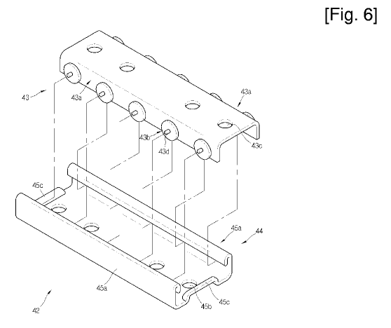

The upper slider 43 has first bending portions 43a formed in both side ends thereof along its length, a roller member 43b installed at regular intervals to the first bending portions 43a, and a coupling hole 43c for coupling with the guide flat plate 16, as shown in FIG. 6.

The lower slider 44 includes second bending portions 45a formed in a length direction thereof to support a shaft 43d of the roller member 43b, a coupling hole 45b for coupling with the gearbox 30, and anti-separation projections 45c formed at both ends thereof to prevent the upper slider 43 from being separated therefrom. The lower slider 44 has a width that ensures the upper slider 43 to be installed between the second bending portions 45a.

In the slider member 42 configured as above, the upper slider 43 is installed to the lower slider 44, and then the upper slider 43 slides with respect to the lower slider 44 by means of rotation of the roller member 43b. That is to say, as shown in FIG. 5, the upper slider 43 may slide with respect to the lower slider 44 within a predetermined range, namely between the anti-separation projections 45c, so the gearbox 30 may slide within a predetermined range with respect to the reciprocating direction of the transferring table 10.

The elastic member 46 includes an elastic spring 47, and a fixing flat plate 48 for fixing the elastic spring 47 to the guide flat plate 16 as shown in FIG. 5. The elastic member 46 biases the pinion gear 32 to be closely contacted with the rack gear 12.

The elastic spring 47 has one end connected to the gearbox 30 and the other end connected to the fixing flat plate 48. The number of elastic springs 47 may be selected in consideration of weight of the gearbox 30 and required biasing force.

The fixing flat plate 48 is installed to the lower surface of the guide flat plate 16 and fixes the other end of the elastic spring 47. The fixing flat plate 48 has a coupling hole 49 in which a coupling member for coupling with the guide flat plate 16 is installed.

As mentioned above, the gearbox 30 may slide within a predetermined range by means of the sliding member 42 and at the same time the pinion gear 32 may be biased by the elastic member 46 to closely contact with the rack gear 12, thereby preventing the gear from running idle. Thus, it allows accurate and precise printing.

The spray assembly 80 contains liquid material and sprays the liquid material with reciprocating in a direction perpendicular to the moving direction of the transferring table 10. The spray assembly 80 is commonly used in printers, and not described in detail here.

Now, the operation procedure of the ascent and descent apparatus 100 for a liquid material spray printer according to a preferred embodiment of the present invention is described in detail. The ascent and descent apparatus 100 is installed to a liquid material spray printer 200 and works together with it, so the operation of the liquid material spray printer 200 is described together.

First, a subject (not shown) to be coated is mounted on the upper surface of the sliding flat table 11. At this time, the subject is preferably mounted to a position corresponding to the first protrusion 13a. In this case, the first sensor 17a detects the position of the subject and controls operation of the spray assembly 80. That is to say, if the sliding flat table 11 advances to make the first protrusion 13a reach the first sensor 17a, the spray assembly 80 starts printing.

Subsequently, a driving force is transferred to the rack gear 12 so that the sliding flat table 11 moves below the spray assembly 80. That is to say, the sliding flat table 11 advances so that the first protrusion 13a reaches the first sensor 17a.

After the subject is moved below the spray assembly 80, a controller (not shown) and a height sensor 17e sense an actual distance between the spray assembly 80 and the upper surface of the subject and then compare it with an optimal coating distance. After the actual distance is compared with the optimal coating distance, the ascent and descent apparatus 100 lifts the transferring plate 10 as much as the difference.

That is to say, the driving motor 66 is selectively operated according to a signal from the controller to rotate the first and second driving gears 66b, 66c. If the second driving gear 66c is rotated, the rotary shaft 60 and the shaft gear 62a to which the second driving gear 66c is installed are rotated, and all rotary shafts 60 rotate at the same revolution number by means of the driving force transferring member 67. As mentioned above, the ascent and descent apparatus 100 rotates a plurality of rotary shafts 60 together at the same speed by means of one driving motor 66 so that the transferring table 10 may be lifted in parallel.

After the transferring plate 10 is lifted to the optimal coating distance, the spray assembly 80 starts printing, and at this same time the transferring table 10 is moved at a predetermined speed. At this time, since the gearbox 30 is installed to be slidable in a direction perpendicular to the movement direction of the transferring table 10 and the elastic member 46 biases the gearbox 30 toward the rack gear 12, the pinion gear 32 is closely contacted with the rack gear 12. That is to say, the driving force is accurately transferred to move the transferring table 10 at an accurate speed, thereby ensuring exact and precise printing.

If the sliding flat table 11 advances and the first protrusion 13a reaches the second sensor 17b, coating of the liquid material is stopped. In addition, if the first protrusion 13a reaches the third sensor 17c, the sliding flat table 11 stops advancing.

Subsequently, the driving motor (not shown) transfers a driving force reversely to move the sliding flat table 11 rearward to a printing start position.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the ascent and descent apparatus for a liquid material spray printer according to the present invention may control a distance between a subject to be coated and the spray assembly to an optimal coating distance required for printing, so it may be applied to subjects with various sizes and shapes.

1. An ascent and descent apparatus for a liquid material spray printer, comprising:
a predetermined number of rotary shafts installed in a vertical direction and having spiral ridges on outer circumferences thereof, the rotary shafts being selectively rotated by a driving motor; and
a lifting member installed to the rotary shafts to support a transferring table to which a subject to be coated is mounted, the lifting member having a spiral ridge with a shape conforming to the spiral ridges of the rotary shafts so that the transferring table is lifted when the rotary shafts are rotated.

2. The ascent and descent apparatus for a liquid material spray printer according to claim 1, wherein the rotary shafts include:
a shaft gear installed to each of the rotary shafts; and
a driving force transferring member installed for connecting the shaft gears with each other so as to transfer a driving force,
whereby at least two driving rotary shaft are selectively rotated using one driving motor at the same time.

3. The ascent and descent apparatus for a liquid material spray printer according to claim 2, further comprising:
a tension pulley installed between the rotary shafts to make the driving force transferring member be curved so that a predetermined tension is provided to the driving force transferring member.

4. The ascent and descent apparatus for a liquid material spray printer according to claim 3, further comprising:
a sensor for sensing a distance between the subject installed to the transferring table and a spray assembly for spraying liquid material; and
a controller for comparing the distance with an optimal coating distance required for printing and then selectively operating the driving motor.
